(19) United States
(12) Patent Application Publication
(10) Pub. No.: US 2025/0337157 A1
(43) Pub. Date: Oct. 30, 2025

(54) CONDUCTIVE MESH FOR TRANSPARENT ANTENNAS AND ACTIVE DIMMING LAYERS

(71) Applicant: Meta Platforms Technologies, LLC, Menlo Park, CA (US)

(72) Inventors: Yasuo Morimoto, Cupertino, CA (US); Jiang Zhu, Cupertino, CA (US); Afsoon Jamali, Issaquah, WA (US); Boon Shiu, Palo Alto, CA (US)

(21) Appl. No.: 19/097,111

(22) Filed: Apr. 1, 2025

Related U.S. Application Data
(60) Provisional application No. 63/638,556, filed on Apr. 25, 2024.

(51) Int. Cl. H01Q 1/38; H01Q 9/04

(52) U.S. Cl. CPC H01Q 1/38; H01Q 9/0407

(57) ABSTRACT

The disclosed system may include a conductive mesh layer. The conductive mesh layer may include a lattice that has multiple different electrically conductive links. The electrically conductive links may be shaped according to at least one specified form. The system may also include an active dimming layer that may be configured to provide active dimming according to a control signal. The system may further include an antenna feed connected to the conductive mesh layer. The antenna feed circuitry may drive the conductive mesh layer as a radiating element of an antenna. Various other apparatuses, systems, and mobile electronic devices are also disclosed.

### CROSS REFERENCE TO RELATED APPLICATION

The present application claims the benefit under 35 U.S.C. § 119 (e) of U.S. Provisional Patent Application No. 63/638,556, filed Apr. 25, 2024, the disclosure of which is hereby incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an embodiment of a conductive mesh according to at least one embodiment of the present disclosure.

FIGS. 2A and 2B illustrate an alternative embodiment of a conductive mesh according to at least one embodiment of the present disclosure.

FIG. 3 illustrates an alternative embodiment of a conductive mesh according to at least one embodiment of the present disclosure.

FIGS. 4A and 4B illustrate alternative embodiments of a conductive mesh according to at least one embodiment of the present disclosure.

FIG. 5 illustrates an alternative embodiment of a conductive mesh according to at least one embodiment of the present disclosure.

FIG. 6 illustrates an alternative embodiment of a conductive mesh according to at least one embodiment of the present disclosure.

FIG. 7 illustrates an alternative embodiment of a conductive mesh according to at least one embodiment of the present disclosure.

FIGS. 8A and 8B illustrate alternative embodiments of a multilayered conductive mesh according to at least one embodiment of the present disclosure.

FIG. 9 illustrates an alternative embodiment of a conductive mesh according to at least one embodiment of the present disclosure.

FIGS. 10A-10C illustrate an embodiment of a system that includes an active dimming layer and a conductive mesh according to at least one embodiment of the present disclosure.

FIG. 11 is an illustration of exemplary augmented-reality glasses that may be used in connection with embodiments of this disclosure.

FIG. 12 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is directed to a system that provides an improved conductive mesh for transparent antennas and active dimming layers. In some cases, conductive meshes have been implemented in the lenses of augmented reality (AR) glasses, on the surface of smartwatches, or on the surfaces of other mobile electronic devices. The conductive meshes are transparent to the user and allow the space on the lenses of the glasses to be used as an antenna and/or active dimming layer. That said, however, while conductive meshes have been implemented on the surfaces of these devices, at least in some cases, various challenges exist in optimizing the functionality of these meshes, particularly concerning the integration of metal meshes within the active dimming layers of AR glasses. For instance, in some cases, use of metal meshes may result in optical scattering and diffraction, which may be noticeable and distracting to users of these devices.

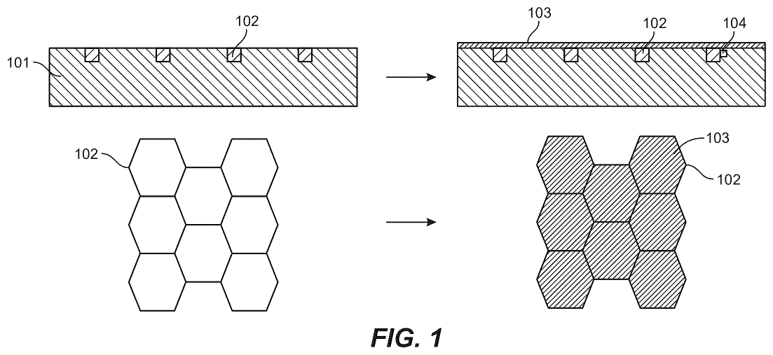

The present disclosure provides embodiments that enhance the performance and efficiency of conductive meshes that are used as transparent antennas, particularly in implementations that also involve active dimming layers. The embodiments herein may implement sine curved lines in the metal mesh lattice to reduce optical scattering and control the resulting diffraction patterns. This may allow the systems herein to achieve both sheet resistance uniformity and enhanced optical transparency. Moreover, the embodiments herein may implement a solid pattern bus bar that is formed on a metal mesh substrate. The metal mesh substrate may then be covered by a sealing material. The solid pattern bus bar may increase the active area of the dimming layer while improving antenna performance. These improvements over other technologies may provide a more effective and efficient solution for applications that implement high-performance active dimming and transparent antenna technologies. These embodiments will be explained below in greater detail with regard to FIGS. 1-12.

Features from any of the embodiments described herein may be used in combination with one another in accordance with the general principles described herein. These and other embodiments, features, and advantages will be more fully understood upon reading the following detailed description in conjunction with the accompanying drawings and claims.

FIG. 1 illustrates a cross-sectional view of a system that includes a substrate 101, a conductive mesh layer 102, and an active dimming layer 103. As shown in FIG. 1, the conductive mesh layer (e.g., a metal mesh (MM) layer) may be integrated within the substrate 101. The substrate may be made of glass, plastic, or other suitable transparent material. At least in some cases, the substrate 101 may be part of a glass lens that is implemented on a pair of AR glasses or on the surface of a smartwatch. The glass lens may also include an active dimming layer configured to provide increased dimming in bright light and decreased dimming in lower light situations. At least in some cases, the active dimming (AD) layer may be made of indium tin oxide (ITO), indium zinc oxide (IZO), silicon nanowire (SNW), graphene, or other material. Some embodiments herein may simply refer to the AD layer as an ITO layer, although other materials may be used.

At least in some embodiments, the conductive mesh layer 102 may form a lattice structure. That lattice structure may serve as a radiating element for an antenna or as an electronically controllable dimming layer. The antenna may be substantially any type of antenna, including a monopole, dipole, loop, slot, inverted-F, planar inverted-F, or other type of antenna. The conductive mesh layer 102 may be electrically connected to an antenna feed 104. The antenna feed circuitry may include signal processors, amplifiers, tuners, or other electronic components that drive the antenna. Accordingly, because the antenna feed circuitry 104 is electrically connected to the conductive mesh layer 102, the antenna feed may drive the conductive mesh layer, which enables the mesh layer to function as a transparent antenna or active dimming element.

The active dimming layer 103 may be configured to provide active dimming according to a control signal. The control signal may come from a controller or processor that is part of the system or device. While a single active dimming layer is shown, it will be understood that multiple layers of active dimming material may be implemented. At least in some cases, the ITO layer 103 may be positioned on top of the conductive mesh layer 102, when viewed from the side. Because the substrate 101, the conductive mesh layer 102, and the AD layer 103 are transparent, a user may be able to see through all three layers. As such, these three layers allow the system to provide both active dimming functions and antenna functions for a mobile electronic device while allowing users to still see through the lenses without obstructions.

As noted above, the conductive mesh layer 102 may form a lattice structure. In FIG. 1, the lattice structure is formed out of conjoined hexagons. While hexagons are used to describe many of the embodiments herein, it will be understood that the lattice structure of the conductive mesh layer 102 may be formed in substantially any shape, including a mixture of different shapes or a mixture of different edges or segments. Indeed, while many of the segments are shown as being straight, the embodiments herein may implement curved segments (specifically, sine-curved segments), straight segments, randomly shaped segments, or segments of different shapes.

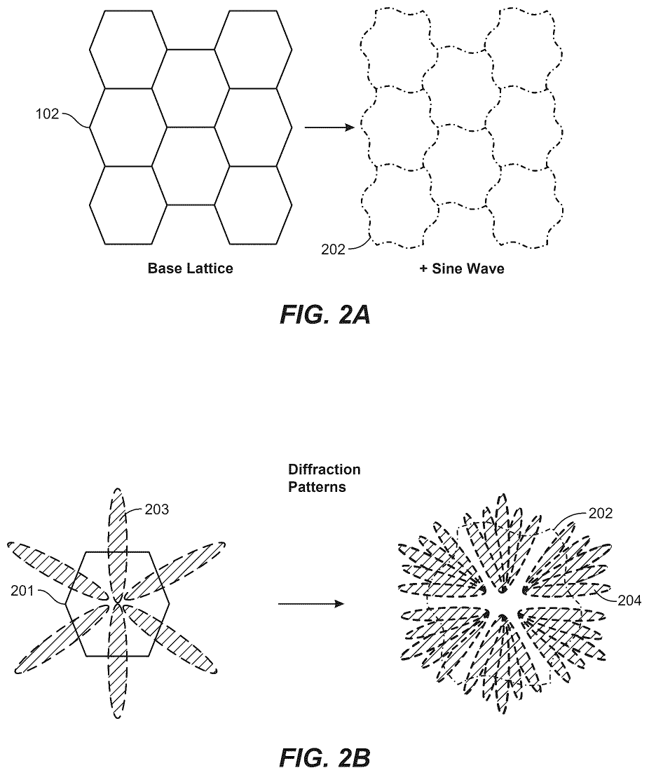

For example, as shown in FIG. 2A, one or more of the electrically conductive lattice links in the base lattice 201 may be shaped in the form of a curve. In some cases, the curve may be a sine curve. The base lattice 2001 may include multiple different segments, some or all of which may be shaped in a sine curve. The overall shape of the lattice may still be conjoined hexagons, as in FIG. 1 and as in 201 of FIG. 2A, although other shapes may be used. The diffraction pattern of the conductive lattice links may change greatly between implementations. For instance, as shown in FIG. 2B, the diffraction patterns 203 of the base lattice 201 may include six general diffraction patterns, one for each segment or link of the hexagon. In contrast, the sine-curved segments 202 may each have five or more diffractions patterns 204 for a single segment, totaling 30 or more diffraction patterns for a single hexagonal lattice cell. In this manner, each hexagon (or other shape) in the conductive lattice may emit a larger amount of the drive signal provided by the antenna feed circuitry. Similarly, the sine-curve diffractions patterns may allow more external signal to be received at a transparent antenna that implements a sine-curved conductive lattice.

At least in some embodiments, the amplitude of the sine curve may be less than 10%, or less than 20%, or less than 30% of the sine period. The number of peaks in the sine curve may be one, two, three, four, or more. As will be shown further below, the sine curve may have a phase delay (i.e., a location shift) with different lattice tracks. In some cases, the pitch of the lattice pitch may be equal to or more than 100 um, more than 300 um, more than 500 um, more than 1000 um, or more than 1500 um. The differences in pitch may make the conductive lattice more or less suitable to operation at different frequencies (e.g., smaller pitch may be better for operating at a lower transmission or receiving frequency, while a larger pitch may be better for operating at a higher frequency). At least in some embodiments, the conductive lattice may alternatively be incorporated into the active dimming layer instead of or in addition to being incorporated in the substrate. In such cases, the sine wave lattice may be implemented to perform active dimming across the lens (i.e., operate as an optical light control layer). In other cases, the sine wave lattice may be implemented for just antenna functions or for both active dimming and antenna functions.

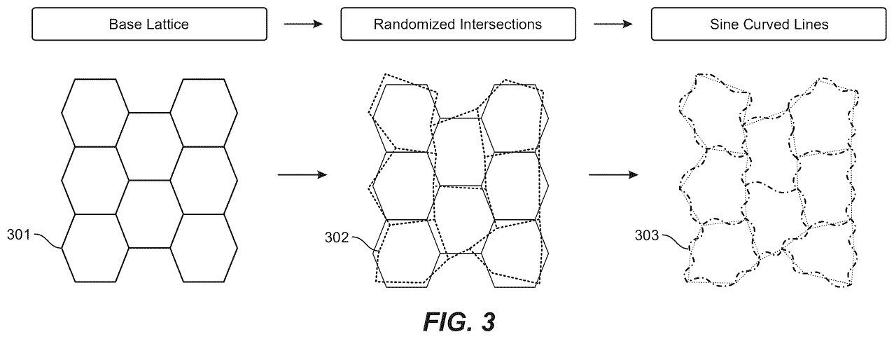

In some cases, the base lattice may be randomized. For instance, as shown in FIG. 3, the base lattice 301 with uniform hexagons having segments that meet at uniform and repeating locations may be formed or shaped in a randomized manner. Indeed, as shown at 302, the randomized lattice may include many randomized intersections and may have segments of different lengths that meet at different locations. Thus, some segments may be shorter or longer, and may intersect at different locations. Thus, while the lattice remains interconnected, the segments and intersections may be shaped in a random fashion. Within such cases, the segments themselves may be straight lines or may be sine curves (as at 303) or may be curved in some other manner. This randomization may provide different diffraction patterns (e.g., FIG. 2). The randomized diffraction patterns may provide an increased number of diffraction patterns, which may, in turn, increase signal strength provided by an antenna or increase the active dimming functionality of any ITO layers or substrate layers that implement such a randomized lattice 303.

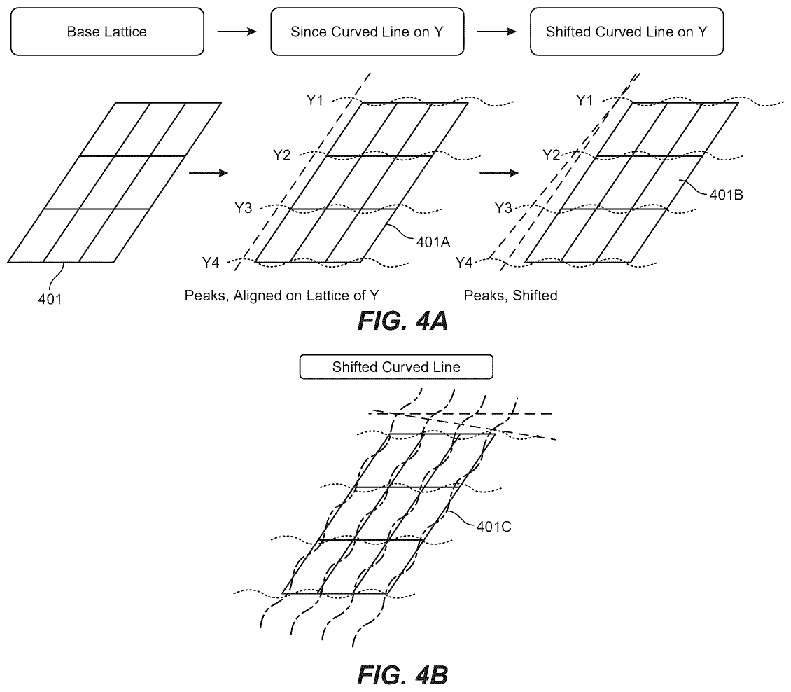

FIG. 4 illustrates an embodiment in which a base lattice 401 may be formed in the shape of a parallelogram made up of a plurality of smaller parallelograms. In some embodiments, some of the straight-line segments may be replaced with sine-curved lines (e.g., Y1, Y2, Y3, and Y4. Thus, in this case (401A), the electrically conductive lattice links are shaped in a straight line along one axis and are shaped in the form of a sine curve on the other axis. Such a configuration may alter the diffraction pattern of the lattice. Still further, the lattice segments Y1-Y4 may not only be formed in the shape of a sine curve, but the segments may also be offset relative to each other (401B).

Thus, in the embodiment 401A, the peaks of the sine-curved lines are aligned on the lattice, while in the embodiment 401B, the peaks of the sine-curved lines have been shifted, causing an angular offset between the sine-curved lines. Again, the shifting of the sine-curved lines may impact the diffraction patterns of the lattice. Designers may craft lattice patterns that are better for certain mobile devices or for certain implementations (e.g., antenna or active dimming) using a specified degree of angular offset between the sine-curved lines. Designers may also change lattice segments along the y-axis (in addition to the x-axis), as shown in embodiment 401C of FIG. 4B. In such cases, the electrically conductive lattice links may be shaped in the form of a sine curve along the y-axis and may also be shaped in the form of a sine curve on the x-axis. The x-or the y-axes may be at least partially shifted horizontally or vertically relative to the other axis.

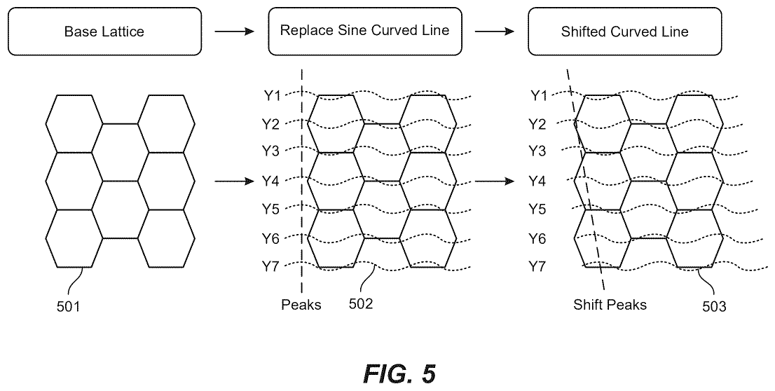

FIG. 5 illustrates an embodiment in which similar segment replacement and shifting may occur. FIG. 5 starts with a hexagonal lattice 501 with straight-line segments. At 502, the straight-line segments along the x-axis have been replaced with sine-curved lines. In the example of 502, the sine-curved lines have peaks that align with each other along the y-axis (e.g., a straight line down through the peaks in each row indicates that the peaks are aligned). In the example of 503, the lattice includes sine-curved segments on each row, but the sine-curved segments have been shifted horizontally, leading to shifted peaks along the y-axis. This, again, may provide a different type of diffraction pattern that may be more advantageous for active dimming or for functioning as an antenna, or for functioning as a particular type of antenna (e.g., dipole or slot, etc.). Accordingly, in this manner, a designer may analyze the diffraction pattern of different embodiments (e.g., 401A-401C or 501-503) to design a lattice with a specific diffraction pattern for a specific implementation.

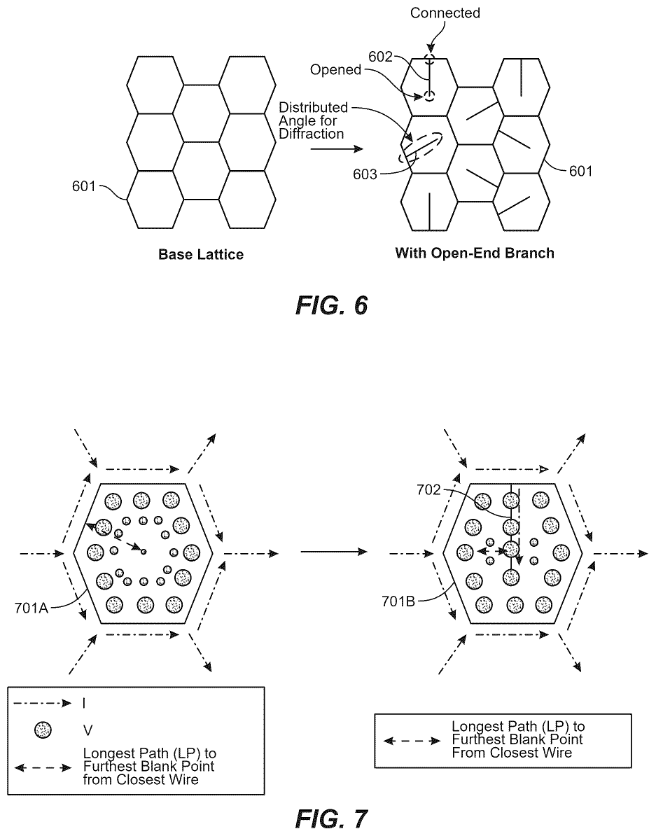

FIG. 6 illustrates an embodiment in which at least one lattice ring of an electrically conductive lattice includes a compensating branch. The compensating branch may be an additional conductive link segment within a lattice that is connected to the lattice on one end and is open (i.e., not connected to the lattice) on the other end. While shown as being straight lines in FIG. 6, it will be understood that the conductive link segments may be shaped in a straight line, in a curved line, or in some other form. The compensating branch may additionally shape the diffraction pattern profile of the lattice. In FIG. 6, the base lattice 601 may have one or many different compensating branches added thereto.

As can be seen, the compensating branch 602 may include one end that is electrically connected to the lattice and one end that is electrically open relative to the lattice. In the case of 602, the compensating branch is arranged vertically within one cell of the lattice, whereas the compensating branch 603 is arranged diagonally within a different cell of the lattice 601. Accordingly, a compensating branch may be placed in substantially any cell of the lattice and may be positioned vertically, horizontally, diagonally, or in some other manner. The compensating branches may provide improved electrical field uniformity across the lattice, enhancing the lattice's function as either an active dimming layer or as an antenna. Indeed, the additional compensating branches may help provide uniformity of current and/or voltage across the lattice.

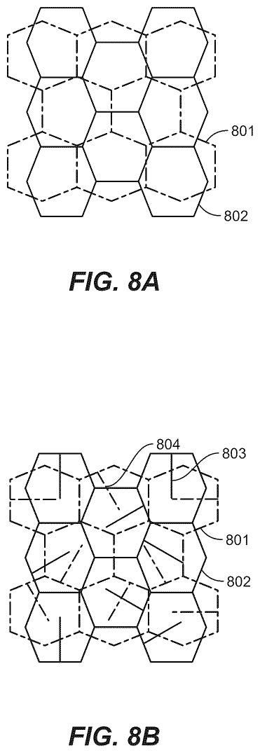

As shown in FIG. 7, in a lattice cell 701A that has no conductive branch, the longest electrical path may be around the entire cell, while in the lattice cell 701B, which has a compensating branch 702, the longest path to the furthest blank point from the closest wire is shorter. As can be seen by the voltage flow (e.g., the large dots) and the current flow (e.g., the solid arrows), the voltage and current flows much more evenly across the lattice cell, providing improved functionality as an active dimming layer or as an antenna.

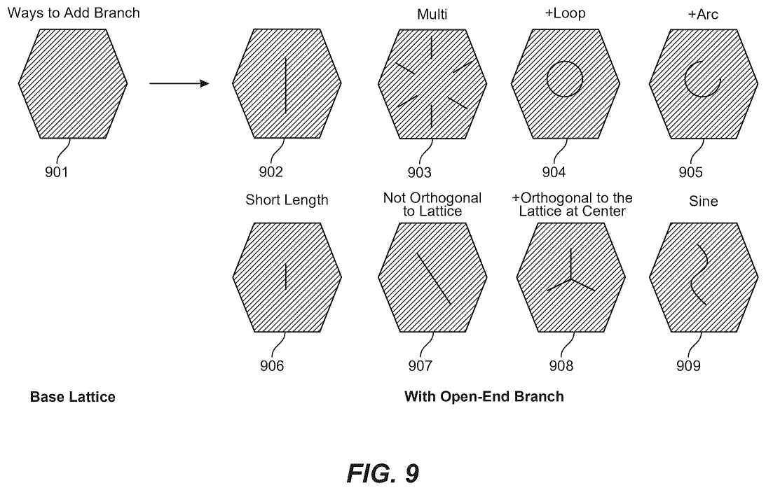

In some cases, as shown in FIG. 8A, multiple conductive mesh layers may be implemented on the same substrate or in the same active dimming layer. For instance, a base lattice may be applied on one layer of a substrate or ITO layer, and a second conductive mesh layer may be applied on another layer, either higher or lower on the substrate or the ITO layer. At least in some embodiments, the second conductive mesh layer may be shaped in a different form than the first conductive mesh layer. Thus, as can be seen in FIG. 8A, the base conductive lattice 801 includes hexagons of a specified width and height, while the second conductive lattice 802 includes hexagons that are rotated and may be of a different width and/or height. Three or more layers of conductive lattices are also possible within a substrate and/or an ITO layer.

FIG. 8B illustrates an embodiment in which two different conductive lattices 801 and 802 are implemented within a substrate and/or active dimming layer. In this scenario, each of the conductive lattices has a compensating branch (e.g., 803/804). As noted above, the compensating branches may be positioned on substantially any part of a lattice cell and may be straight-line segments or curved-line segments. Each compensating branch 803/804 may include one connected portion and an electrically open portion.

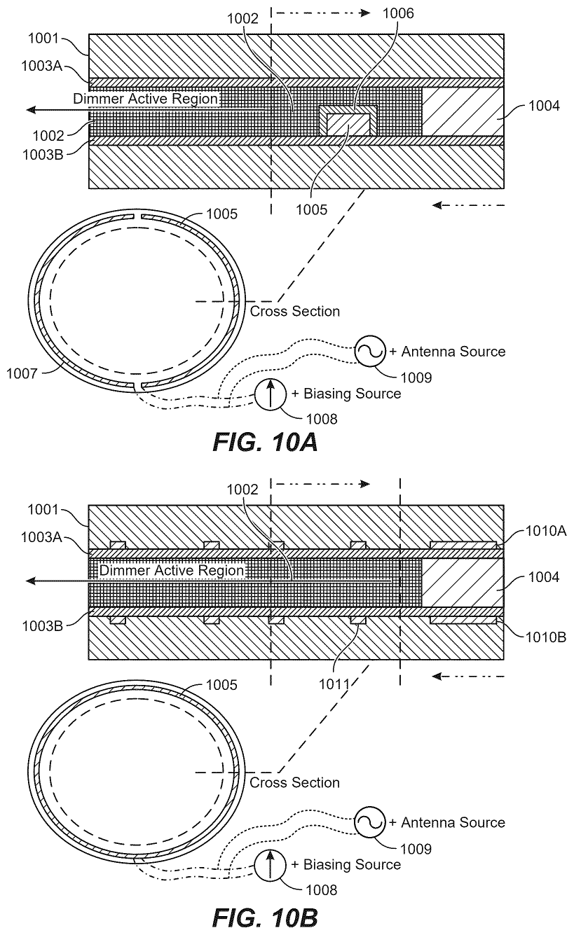

At least in some cases, the conductive link segments of the compensating branches may include different types or shapes. For instance, as shown in FIG. 9, a conductive lattice cell 901 may allow conductive branches to be added in a variety of different manners. For instance, a longer-length or shorter-length conductive link may be positioned in the middle of the cell (e.g., 902 or 906). Other conductive link segments may include multiple small straight-line links (e.g., six small conductive link segments at 903, each one being connected to the middle of a hexagonal cell element).

Still further, other conductive link segments may include a straight line followed by a circle or loop 904 that lies in the middle of the lattice cell, a straight line followed by an arc 905 that forms an incomplete loop in the middle of the lattice cell, a segment that is non-orthogonal to the lattice cell 907, a branched portion that splits into two different diagonal-line portions extending from the open end 908, a curved-line portion that extends from the cell wall 909, or any other shape coming off of a straight-or curved-line connected portion. Each may provide different radiating or current flow characteristics across the conductive lattice.

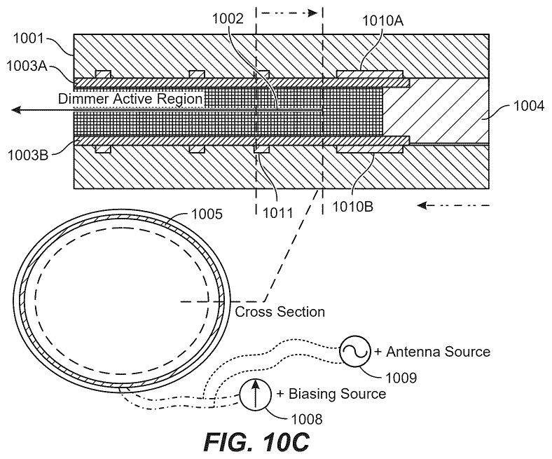

FIGS. 10A-10C illustrate embodiments in which a bus bar may be positioned on an outer portion of a conductive mesh layer. At least in some cases, the active dimming layer of a pair of AR glasses or other mobile electronic device may benefit from a seal around its edges. The AD layer may, in certain situations, be prone to leaking current or voltage through transparent electro nodes. The bus bar may be a conductive ring that surrounds at least a portion of the conductive mesh and the active dimming layer. The bus bar may be made of copper, silver, or other conductive material. The bus bar may be formed as a solid pattern on the conductive mesh layer or on the substrate layer using a sealing material that covers the bus bar.

At least in some embodiments, the bus bar may include a top portion 1007 and a bottom portion 1005. The bus bar 1005 may be surrounded by a protective material 1004. The bus bar itself may be positioned between two active dimming (ITO) layers 1003A and 1003B, which are sandwiched between two substrate layers 1001 (e.g., glass or plastic). A sealing material 1006 may be implemented to protect other areas of the ITO layer. At least in some cases, the embodiments herein attempt to maximize the active region of the dimmer 1002 by moving the bus bar 1005 as far to the edge of the lens or substrate as possible. These embodiments may also attempt to shrink the lossy ITO layer for improved antenna performance. In this configuration, an antenna source 1009 may drive the bus bar (either alone or in conjunction with a biasing source 1008) to radiate the conductive lattice as an antenna.

The embodiment of FIG. 10B may be configured differently such that the bus bar 1005 is a solid ring on both the top layer 1010A and the bottom layer 1010B. The metal mesh lattice 1011 is also visible in this embodiment. As shown in FIG. 10B, the top side bus bar O-ring and the bottom side bus bar O-ring may be positioned under the sealing material 1004. This may provide better antenna performance since the conductive solid pattern O-ring abuts the lossy ITO layers 1003A/1003B. In FIG. 10C, the sealing portion 1004 is enlarged and the bus bar O-rings are moved inward. This may provide improved antenna performance, since the conductive solid pattern bus bar is moved toward the center. This may reduce the active region of the dimmer but may provide room for the increased amount of sealing material 1004, which allows the antenna to experience less signal loss in the lossy ITO layer.

In addition to the system described above, a corresponding mobile electronic device may also be provided. The mobile electronic device may include a conductive mesh layer, where the conductive mesh layer includes a lattice. The lattice includes multiple different electrically conductive links. The electrically conductive links may be shaped according to at least one specified form (e.g., straight line or curved line). The mobile electronic device may also include an active dimming layer configured to provide active dimming according to a control signal. Still further, the mobile electronic device may include an antenna feed connected to the conductive mesh layer, where antenna feed circuitry drives the conductive mesh layer as a radiating element of an antenna.

Additionally or alternatively, a corresponding apparatus may also be provided. The apparatus may include a conductive mesh layer, where the conductive mesh layer includes a lattice. The lattice includes multiple different electrically conductive links. The electrically conductive links may be shaped according to at least one specified form (e.g., straight line or curved line). The mobile electronic device may also include an active dimming layer configured to provide active dimming according to a control signal. Still further, the mobile electronic device may include an antenna feed connected to the conductive mesh layer, where antenna feed circuitry drives the conductive mesh layer as a radiating element of an antenna.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

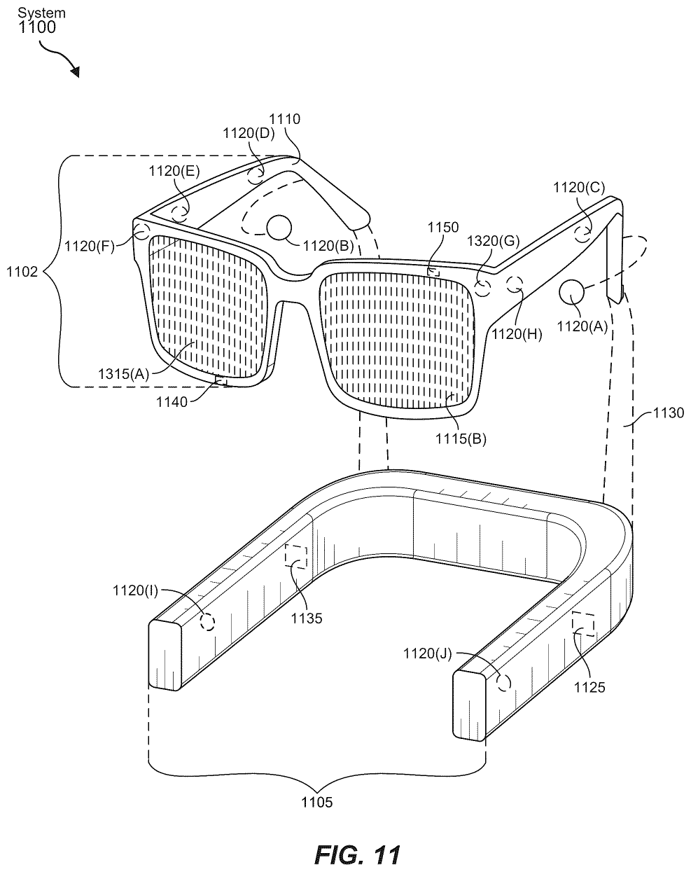

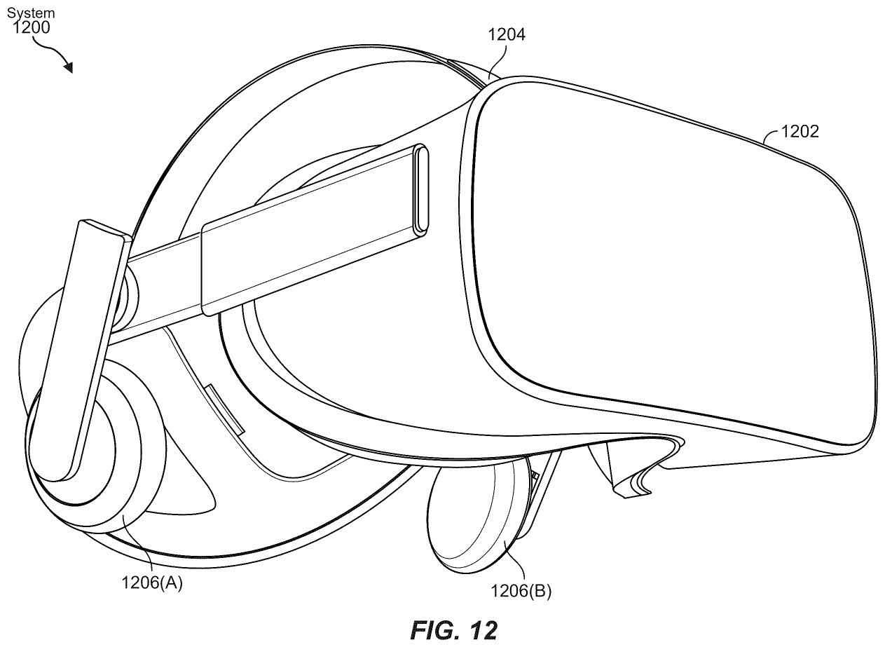

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1100 in FIG. 11) or that visually immerses a user in an artificial reality (such as, e.g., virtual-reality system 1200 in FIG. 12). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 11, augmented-reality system 1100 may include an eyewear device 1102 with a frame 1110 configured to hold a left display device 1115(A) and a right display device 1115(B) in front of a user's eyes. Display devices 1115(A) and 1115(B) may act together or independently to present an image or series of images to a user. While augmented-reality system 1100 includes two displays, embodiments of this disclosure may be implemented in augmented-reality systems with a single NED or more than two NEDs.

In some embodiments, augmented-reality system 1100 may include one or more sensors, such as sensor 1140. Sensor 1140 may generate measurement signals in response to motion of augmented-reality system 1100 and may be located on substantially any portion of frame 1110. Sensor 1140 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1100 may or may not include sensor 1140 or may include more than one sensor. In embodiments in which sensor 1140 includes an IMU, the IMU may generate calibration data based on measurement signals from sensor 1140. Examples of sensor 1140 may include, without limitation, accelerometers, gyroscopes, magnetometers, other suitable types of sensors that detect motion, sensors used for error correction of the IMU, or some combination thereof.

In some examples, augmented-reality system 1100 may also include a microphone array with a plurality of acoustic transducers 1120(A)-1120(J), referred to collectively as acoustic transducers 1120. Acoustic transducers 1120 may represent transducers that detect air pressure variations induced by sound waves. Each acoustic transducer 1120 may be configured to detect sound and convert the detected sound into an electronic format (e.g., an analog or digital format). The microphone array in FIG. 11 may include, for example, ten acoustic transducers: 1120(A) and 1120(B), which may be designed to be placed inside a corresponding ear of the user, acoustic transducers 1120(C), 1120(D), 1120(E), 1120(F), 1120(G), and 1120(H), which may be positioned at various locations on frame 1110, and/or acoustic transducers 1120(I) and 1120(J), which may be positioned on a corresponding neckband 1105.

In some embodiments, one or more of acoustic transducers 1120(A)-(J) may be used as output transducers (e.g., speakers). For example, acoustic transducers 1120(A) and/or 1120(B) may be earbuds or any other suitable type of headphone or speaker.

The configuration of acoustic transducers 1120 of the microphone array may vary. While augmented-reality system 1100 is shown in FIG. 11 as having ten acoustic transducers 1120, the number of acoustic transducers 1120 may be greater or less than ten. In some embodiments, using higher numbers of acoustic transducers 1120 may increase the amount of audio information collected and/or the sensitivity and accuracy of the audio information. In contrast, using a lower number of acoustic transducers 1120 may decrease the computing power required by an associated controller 1150 to process the collected audio information. In addition, the position of each acoustic transducer 1120 of the microphone array may vary. For example, the position of an acoustic transducer 1120 may include a defined position on the user, a defined coordinate on frame 1110, an orientation associated with each acoustic transducer 1120, or some combination thereof.

Acoustic transducers 1120(A) and 1120(B) may be positioned on different parts of the user's ear, such as behind the pinna, behind the tragus, and/or within the auricle or fossa. Or, there may be additional acoustic transducers 1120 on or surrounding the ear in addition to acoustic transducers 1120 inside the ear canal. Having an acoustic transducer 1120 positioned next to an ear canal of a user may enable the microphone array to collect information on how sounds arrive at the ear canal. By positioning at least two of acoustic transducers 1120 on either side of a user's head (e.g., as binaural microphones), augmented-reality system 1100 may simulate binaural hearing and capture a 3D stereo sound field around about a user's head. In some embodiments, acoustic transducers 1120(A) and 1120(B) may be connected to augmented-reality system 1100 via a wired connection 1130, and in other embodiments acoustic transducers 1120(A) and 1120(B) may be connected to augmented-reality system 1100 via a wireless connection (e.g., a BLUETOOTH connection). In still other embodiments, acoustic transducers 1120(A) and 1120(B) may not be used at all in conjunction with augmented-reality system 1100.

Acoustic transducers 1120 on frame 1110 may be positioned in a variety of different ways, including along the length of the temples, across the bridge, above or below display devices 1115(A) and 1115(B), or some combination thereof. Acoustic transducers 1120 may also be oriented such that the microphone array is able to detect sounds in a wide range of directions surrounding the user wearing the augmented-reality system 1100. In some embodiments, an optimization process may be performed during manufacturing of augmented-reality system 1100 to determine relative positioning of each acoustic transducer 1120 in the microphone array.

In some examples, augmented-reality system 1100 may include or be connected to an external device (e.g., a paired device), such as neckband 1105. Neckband 1105 generally represents any type or form of paired device. Thus, the following discussion of neckband 1105 may also apply to various other paired devices, such as charging cases, smart watches, smart phones, wrist bands, other wearable devices, hand-held controllers, tablet computers, laptop computers, other external compute devices, etc.

As shown, neckband 1105 may be coupled to eyewear device 1102 via one or more connectors. The connectors may be wired or wireless and may include electrical and/or non-electrical (e.g., structural) components. In some cases, eyewear device 1102 and neckband 1105 may operate independently without any wired or wireless connection between them. While FIG. 11 illustrates the components of eyewear device 1102 and neckband 1105 in example locations on eyewear device 1102 and neckband 1105, the components may be located elsewhere and/or distributed differently on eyewear device 1102 and/or neckband 1105. In some embodiments, the components of eyewear device 1102 and neckband 1105 may be located on one or more additional peripheral devices paired with eyewear device 1102, neckband 1105, or some combination thereof.

Pairing external devices, such as neckband 1105, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1100 may be provided by a paired device or shared between a paired device and an eyewear device, thus reducing the weight, heat profile, and form factor of the eyewear device overall while still retaining desired functionality. For example, neckband 1105 may allow components that would otherwise be included on an eyewear device to be included in neckband 1105 since users may tolerate a heavier weight load on their shoulders than they would tolerate on their heads. Neckband 1105 may also have a larger surface area over which to diffuse and disperse heat to the ambient environment. Thus, neckband 1105 may allow for greater battery and computation capacity than might otherwise have been possible on a stand-alone eyewear device. Since weight carried in neckband 1105 may be less invasive to a user than weight carried in eyewear device 1102, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1105 may be communicatively coupled with eyewear device 1102 and/or to other devices. These other devices may provide certain functions (e.g., tracking, localizing, depth mapping, processing, storage, etc.) to augmented-reality system 1100. In the embodiment of FIG. 11, neckband 1105 may include two acoustic transducers (e.g., 1120(I) and 1120(J)) that are part of the microphone array (or potentially form their own microphone subarray). Neckband 1105 may also include a controller 1125 and a power source 1135.

Acoustic transducers 1120(I) and 1120(J) of neckband 1105 may be configured to detect sound and convert the detected sound into an electronic format (analog or digital). In the embodiment of FIG. 11, acoustic transducers 1120(I) and 1120(J) may be positioned on neckband 1105, thereby increasing the distance between the neckband acoustic transducers 1120(I) and 1120(J) and other acoustic transducers 1120 positioned on eyewear device 1102. In some cases, increasing the distance between acoustic transducers 1120 of the microphone array may improve the accuracy of beamforming performed via the microphone array. For example, if a sound is detected by acoustic transducers 1120(C) and 1120(D) and the distance between acoustic transducers 1120(C) and 1120(D) is greater than, e.g., the distance between acoustic transducers 1120(D) and 1120(E), the determined source location of the detected sound may be more accurate than if the sound had been detected by acoustic transducers 1120(D) and 1120(E).

Controller 1125 of neckband 1105 may process information generated by the sensors on neckband 1105 and/or augmented-reality system 1100. For example, controller 1125 may process information from the microphone array that describes sounds detected by the microphone array. For each detected sound, controller 1125 may perform a direction-of-arrival (DOA) estimation to estimate a direction from which the detected sound arrived at the microphone array. As the microphone array detects sounds, controller 1125 may populate an audio data set with the information. In embodiments in which augmented-reality system 1100 includes an inertial measurement unit, controller 1125 may compute all inertial and spatial calculations from the IMU located on eyewear device 1102. A connector may convey information between augmented-reality system 1100 and neckband 1105 and between augmented-reality system 1100 and controller 1125. The information may be in the form of optical data, electrical data, wireless data, or any other transmittable data form. Moving the processing of information generated by augmented-reality system 1100 to neckband 1105 may reduce weight and heat in eyewear device 1102, making it more comfortable to the user.

Power source 1135 in neckband 1105 may provide power to eyewear device 1102 and/or to neckband 1105. Power source 1135 may include, without limitation, lithium-ion batteries, lithium-polymer batteries, primary lithium batteries, alkaline batteries, or any other form of power storage. In some cases, power source 1135 may be a wired power source. Including power source 1135 on neckband 1105 instead of on eyewear device 1102 may help better distribute the weight and heat generated by power source 1135.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1200 in FIG. 12, that mostly or completely covers a user's field of view. Virtual-reality system 1200 may include a front rigid body 1202 and a band 1204 shaped to fit around a user's head. Virtual-reality system 1200 may also include output audio transducers 1206(A) and 1206(B). Furthermore, while not shown in FIG. 12, front rigid body 1202 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1100 and/or virtual-reality system 1200 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1100 and/or virtual-reality system 1200 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1100 and/or virtual-reality system 1200 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

### Example Embodiments

Example 1: A system may include a conductive mesh layer, wherein the conductive mesh layer includes a lattice comprising a plurality of different electrically conductive links, and wherein the electrically conductive links are shaped according to at least one specified form; an active dimming layer configured to provide active dimming according to a control signal; and an antenna feed connected to the conductive mesh layer, wherein antenna feed circuitry drives the conductive mesh layer as a radiating element of an antenna.

Example 2: The system of Example 1, wherein the electrically conductive lattice links are shaped in the form of a sine curve.

Example 3: The system of Example 1 or Example 2, wherein the electrically conductive lattice links are shaped in a straight line along a first axis and shaped in the form of a sine curve on a second axis.

Example 4: The system of any of Examples 1-3, wherein the electrically conductive lattice links are shaped in the form of a sine curve along a first axis and are also shaped in the form of a sine curve on a second axis.

Example 5: The system of any of Examples 1-4, wherein the second axis is at least partially shifted horizontally or vertically relative to the first axis.

Example 6: The system of any of Examples 1-5, wherein the electrically conductive lattice links are shaped in a random pattern and intersect with each other at random locations on the conductive mesh layer.

Example 7: The system of any of Examples 1-6, wherein at least one lattice ring of the electrically conductive lattice includes at least one compensating branch.

Example 8: The system of any of Examples 1-7, wherein the compensating branch includes one or more conductive link segments.

Example 9: The system of any of Examples 1-8, wherein the conductive link segments are at least one of straight or curved.

Example 10: The system of any of Examples 1-9, wherein at least one of the conductive link segments includes at least one branched portion.

Example 11: The system of any of Examples 1-10, further comprising a second conductive mesh layer that is shaped in a different specified form.

Example 12: The system of any of Examples 1-11, further comprising a bus bar positioned on an outer portion of the conductive mesh layer.

Example 13: The system of any of Examples 1-12, wherein the bus bar comprises a conductive ring that surrounds at least a portion of the conductive mesh and the active dimming layer.

Example 14: The system of any of Examples 1-13, wherein the bus bar is formed as a solid pattern on the conductive mesh layer using a sealing material.

Example 15: A mobile electronic device may include a conductive mesh layer, wherein the conductive mesh layer includes a lattice comprising a plurality of different electrically conductive links, and wherein the electrically conductive links are shaped according to at least one specified form; an active dimming layer configured to provide active dimming according to a control signal; and an antenna feed connected to the conductive mesh layer, wherein antenna feed circuitry drives the conductive mesh layer as a radiating element of an antenna.

Example 16: The mobile electronic device of any of Examples 13-15, wherein the electrically conductive lattice links are shaped in the form of a sine curve.

Example 17: The mobile electronic device of any of Examples 13-16, wherein the electrically conductive lattice links are shaped in a straight line along a first axis and shaped in the form of a sine curve on a second axis.

Example 18: The mobile electronic device of any of Examples 13-17, wherein the electrically conductive lattice links are shaped in the form of a sine curve along a first axis and are also shaped in the form of a sine curve on a second axis.

Example 19: The mobile electronic device of any of Examples 13-18, wherein the second axis is at least partially shifted horizontally or vertically relative to the first axis.

Example 20: An apparatus may include a conductive mesh layer, wherein the conductive mesh layer includes a lattice comprising a plurality of different electrically conductive links, and wherein the electrically conductive links are shaped according to at least one specified form; an active dimming layer configured to provide active dimming according to a control signal; and an antenna feed connected to the conductive mesh layer, wherein antenna feed circuitry drives the conductive mesh layer as a radiating element of an antenna.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a conductive mesh layer, wherein the conductive mesh layer includes a lattice comprising a plurality of different electrically conductive links, and wherein the electrically conductive links are shaped according to at least one specified form;
an active dimming layer configured to provide active dimming according to a control signal; and
an antenna feed connected to the conductive mesh layer, wherein antenna feed circuitry drives the conductive mesh layer as a radiating element of an antenna.

2. The system of claim 1, wherein the electrically conductive lattice links are shaped in the form of a sine curve.

3. The system of claim 2, wherein the electrically conductive lattice links are shaped in a straight line along a first axis and shaped in the form of a sine curve on a second axis.

4. The system of claim 2, wherein the electrically conductive lattice links are shaped in the form of a sine curve along a first axis and are also shaped in the form of a sine curve on a second axis.

5. The system of claim 4, wherein the second axis is at least partially shifted horizontally or vertically relative to the first axis.

6. The system of claim 1, wherein the electrically conductive lattice links are shaped in a random pattern and intersect with each other at random locations on the conductive mesh layer.

7. The system of claim 1, wherein at least one lattice ring of the electrically conductive lattice includes at least one compensating branch.

8. The system of claim 7, wherein the compensating branch includes one or more conductive link segments.

9. The system of claim 8, wherein the conductive link segments are at least one of straight or curved.

10. The system of claim 8, wherein at least one of the conductive link segments includes at least one branched portion.

11. The system of claim 7, further comprising a second conductive mesh layer that is shaped in a different specified form.

12. The system of claim 1, further comprising a bus bar positioned on an outer portion of the conductive mesh layer.

13. The system of claim 12, wherein the bus bar comprises a conductive ring that surrounds at least a portion of the conductive mesh and the active dimming layer.

14. The system of claim 13, wherein the bus bar is formed as a solid pattern on the conductive mesh layer using a sealing material.

15. A mobile electronic device, comprising:
a conductive mesh layer, wherein the conductive mesh layer includes a lattice comprising a plurality of different electrically conductive links, and wherein the electrically conductive links are shaped according to at least one specified form;
an active dimming layer configured to provide active dimming according to a control signal; and
an antenna feed connected to the conductive mesh layer, wherein antenna feed circuitry drives the conductive mesh layer as a radiating element of an antenna.

16. The mobile electronic device of claim 15, wherein the electrically conductive lattice links are shaped in the form of a sine curve.

17. The mobile electronic device of claim 16, wherein the electrically conductive lattice links are shaped in a straight line along a first axis and shaped in the form of a sine curve on a second axis.

18. The mobile electronic device of claim 15, wherein the electrically conductive lattice links are shaped in the form of a sine curve along a first axis and are also shaped in the form of a sine curve on a second axis.

19. The mobile electronic device of claim 18, wherein the second axis is at least partially shifted horizontally or vertically relative to the first axis.

20. An apparatus comprising:
a conductive mesh layer, wherein the conductive mesh layer includes a lattice comprising a plurality of different electrically conductive links, and wherein the electrically conductive links are shaped according to at least one specified form;
an active dimming layer configured to provide active dimming according to a control signal; and
an antenna feed connected to the conductive mesh layer, wherein antenna feed circuitry drives the conductive mesh layer as a radiating element of an antenna.
